(19) United States
(12) Patent Application Publication
(10) Pub. No.: US 2026/0233587 A1
(43) Pub. Date: Aug. 13, 2026

(54) RETRACTABLE SUNSHADE FOR CAR WINDOWS

(71) Applicant: Guangzhou Cartist Technology Limited, Guangzhou (CN)

(72) Inventor: Xiaolan CHEN, Guangzhou (CN)

(21) Appl. No.: 19/530,548

(22) Filed: Feb. 5, 2026

(30) Foreign Application Priority Data
Feb. 10, 2025 (CN) 202520205181.5

(51) Int. Cl. B60J 1/20

(52) U.S. Cl. CPC B60J 1/2063

(57) ABSTRACT

Provided is a retractable sunshade for car windows, which includes a seat body, a roller blind, and a hook. The seat body includes a main body, an upper base, and a lower base. The roller blind is rolled up into the main body, the hook is provided at a rolled-out end of the roller blind. The upper base is fixedly provided at one end of the main body, the lower base is provided at an inner lining of a car door. A quick release structure is provided between the upper base and the lower base. Through the quick release structure, the retractable sunshade can be disassembled from the inner lining of the car door and the lower base is still on the inner lining of the car door. The retractable sunshade for car windows can balance the convenience of disassembly and assembly, and the aesthetics and comfort after disassembly.

### CROSS-REFERENCE TO RELATED APPLICATIONS

This application claims priority to Chinese Patent Application No. 202520205181.5, filed on Feb. 10, 2025, which is hereby incorporated by reference in its entirety.

### TECHNICAL FIELD

The present disclosure relates to the field of auto parts technologies, and in particular, to a retractable sunshade for car windows.

### BACKGROUND

In the hot summer weather, due to the poor shading effect of some cars, car owners often face the problem of high temperature inside the car. In recent years, as a new type of window sunshade solution, retractable sunshades have gradually gained attention to compensate for the insufficient sunshade effect inside the car.

CN101537782B discloses an automobile sunshade, which includes a sunshade seat body, a sunshade curtain, and a hook. The sunshade curtain is limited to the sunshade seat body and can be rolled up inside the sunshade seat body. The outer end of the sunshade curtain is a rolled-out end, which can be pulled out or elastically retracted from the rolled-out end. The rolled-out end passes through a rod body, and the rod body is connected to the hook. When implemented, the bottom side of the sunshade seat body is fixed to a top surface of an inner lining of a car door, and is bonded with double-sided tape or a fastener. When the sunlight is strong, by pulling the sunshade curtain out of the sunshade seat body and using the hook to hang it tightly, the sunshade effect inside the car can be effectively improved.

However, since the sunshade seat body of sunshade curtain is an integrated seat body, there may be difficulties in disassembly if it is bonded with double-sided tape. If it is bonded with fastener, one side of the fastener will be left on the top surface of the inner lining of the car door after disassembly, affecting both aesthetics and comfort. It is difficult to balance the convenience of disassembly and assembly with the aesthetics and comfort after disassembly.

### SUMMARY

In order to solve the problems existing in the existing technology, this application provides a retractable sunshade for car windows.

The present disclosure provides a retractable sunshade for car windows, which adopts the following technical solution.

A retractable sunshade for car windows, including: a seat body, a roller blind, and a hook; where the seat body includes a main body, an upper base, and a lower base; the roller blind is rolled up in the main body, the hook is provided at a rolled-out end of the roller blind, the upper base is fixedly provided at one end of the main body, the lower base is provided at an inner lining of a car door, and a quick release structure is provided between the upper base and the lower base; the lower base has remained on the inner lining of the car door when the retractable sunshade is removed from the inner lining of the car door by the quick release structure.

In some embodiments of the present disclosure, the quick release structure between the upper base and the lower base includes a first magnet and a second magnet, where the first magnet is provided at a bottom of the upper base and the second magnet is provided at a top of the lower base.

In some embodiments of the present disclosure, the bottom of the upper base is provided with a first installation slot, and the first magnet is embedded in the first installation slot.

In some embodiments of the present disclosure, a second installation slot is provided at the top of the lower base, the second installation slot is small at a top and large at a bottom, the second installation slot runs through left and right sides of the top of the lower base, and the second magnet is embedded from one side of the top of the lower base.

In some embodiments of the present disclosure, a buckle and a clamp slot are provided between the upper base and the lower base, the buckle is provided on one side of the upper base, and the clamp slot is provided on one side of the lower base; when the upper base is connected to the lower base, the buckle is inserted into the clamp slot.

In some embodiments of the present disclosure, both the upper base and the lower base are plastic parts.

In some embodiments of the present disclosure, a guide block is provided on one side of the upper base, and a guide groove configured for the guide block to slide in is provided between the top and a side of the lower base.

In some embodiments of the present disclosure, a buckle and a clamp slot are provided between the upper base and the lower base, the clamp slot is provided on one side of the upper base, and the buckle is provided on one side of the lower base; when the upper base is connected to the lower base, the buckle is inserted into the clamp slot.

In some embodiments of the present disclosure, the upper base and the lower base are both plastic parts.

In some embodiments of the present disclosure, the buckle also serves as a guide block, and an edge of the clamp slot is provided with a guide groove with a bottom opening, and a bottom of the guide groove is configured for the guide block to enter.

In some embodiments of the present disclosure, the main body includes a tube body, two sides of the tube body of the main body are communicated, and the tube body of the main body is provided with a notch configured for the roller blind to expand and contract. The upper base is provided with a recess on one side facing the tube body of the main body, and when the upper base is fixedly connected to the main body, one end of the tube body of the main body is inserted into the recess of the upper base.

In some embodiments of the present disclosure, the sunshade is made of gauze.

In some embodiments of the present disclosure, the sunshade is made of fabric.

In some embodiments of the present disclosure, a threaded hole is provided between the first installation slot and the first magnet, and a screw is provided between the first installation slot and the first magnet through the threaded hole.

The beneficial effects of the present disclosure are as follows.

When the retractable sunshade is provided on the inner lining of the car door, the 3M adhesive between the lower base and the inner lining of the car door can ensure the stability of the retractable sunshade provided on the inner lining of the car door. When it is necessary to remove the retractable sunshade from the inner lining of the car door, the quick release structure between the upper base and the lower base can facilitate the disassembly of the retractable sunshade, and only two lower bases are retained on the inner lining of the car door, thus maintaining good aesthetics and comfort after removing the sunshade.

### BRIEF DESCRIPTION OF DRAWINGS

FIG. 1 is a schematic structural diagram of a retractable sunshade in embodiment 1.

FIG. 2 is a schematic structural diagram of a main body in embodiment 1.

FIG. 3 is a schematic structural diagram of an upper base in embodiment 1.

FIG. 4 is a schematic structural diagram of a lower base in embodiment 1.

FIG. 5 is an exploded structural view between the upper base and the lower base in embodiment 2.

FIG. 6 is another perspective of FIG. 5.

FIG. 7 is an exploded structural view between the upper base and the lower base in embodiment 3.

Numeral reference: 1—seat body; 2—roller blind; 3—hook; 4—main body; 41—notch; 5—upper base; 51—recess; 52—screw; 6—lower base; 71—first magnet; 72—second magnet; 81—first installation slot; 82—second installation slot; 91—buckle; 92—clamp slot; 93—guide block; 94—guide groove.

### DESCRIPTION OF EMBODIMENTS

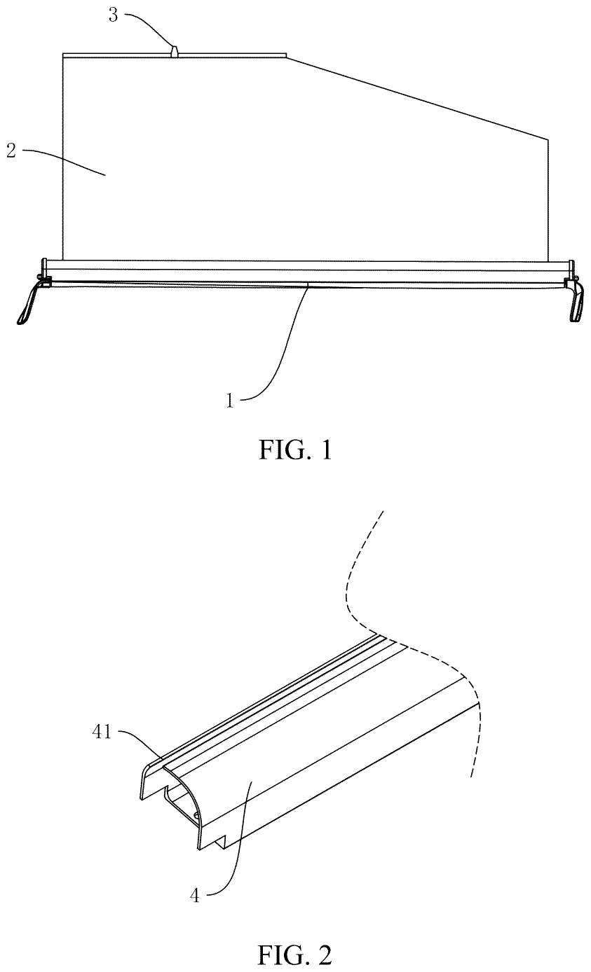

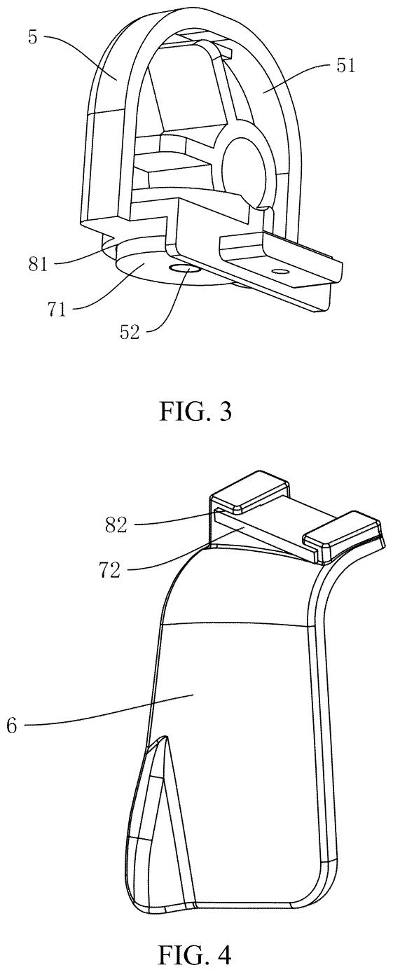

The present disclosure will be further explained in combination with FIGS. 1-7 and the embodiments.

### Embodiment 1

This embodiment discloses a retractable sunshade for car windows.

Referring to FIGS. 1 to 4, the retractable sunshade for car windows includes a seat body 1, a roller blind 2, and a hook 3. The seat body 1 includes a main body 4, an upper base 5, and a lower base 6. The roller blind 2 is rolled up in the main body 4, and the hook 3 is provided at a rolled-out end of the roller blind 2. The upper base 5 is fixedly provided at one end of the main body 4, and the lower base 6 is provided at an inner lining of a car door. A quick release structure is provided between the upper base 5 and the lower base 6. In an implementation mode, there are two upper bases 5 and two lower bases 6. Therefore, this device is arranged as follows: two upper bases 5 are fixed at left and right ends of the main body 4, and the lower bases 6 are bonded to the inner lining of the car door. In an implementation mode, the two lower bases 6 are bonded to left and right sides of a top of the inner lining of the car door.

Through the above settings, when the retractable sunshade is provided on the inner lining of the car door, an adhesive between the lower base 6 and the inner lining of the car door can ensure the stability of the retractable sunshade provided on the inner lining of the car door. When it is necessary to remove the retractable sunshade from the inner lining of the car door, the quick release structure between the upper bases 5 and the lower bases 6 can facilitate the disassembly of the retractable sunshade, and only two lower bases 6 are retained on the inner lining of the car door, thus maintaining good aesthetics and comfort after removing the sunshade. By using the quick release structure to remove the retractable sunshade from the inner lining of the car door, the lower bases 6 remain on the inner lining of the car door.

In this embodiment, 3M glue is used as the adhesive.

It should be noted that shapes of the two lower bases 6 are designed according to the shapes of different inner linings of the car door, ensuring that the lower bases 6 can be stably adhered to the left and right sides of the top of the inner lining of the car door with 3M adhesive. In this embodiment, when the retractable sunshade is provided on a rear door of the car, the two lower bases 6 form two opposite “7” shapes.

The main body 4 includes a hollow tube body, two ends of the tube body are communicated. The tube body of the main body 4 is provided with a notch 41 for the expansion and contraction of the roller blind 2 along an axial direction on one side close to the car window. In an implementation mode, the upper base 5 has a recess 51 on one side facing the tube body of the main body 4. When the upper base 5 is fixedly connected to the main body 4, one end of the tube body of the main body 4 is inserted into the recess 51 of the upper base 5. The tube body of the main body 4 tends to expand due to its own notch 41. Therefore, the tube body of the main body 4 can support the upper base 5 tightly, thereby improving the stability of the connection between the two.

In this embodiment, there is a magnetic attraction connection between the upper base 5 and the lower base 6. In an implementation mode, the quick detachable structure between the upper base 5 and the lower base 6 includes a first magnet 71 and a second magnet 72. The first magnet 71 is provided at a bottom of the upper base 5, and the second magnet 72 is provided at a top of the lower base 6. When the upper base 5 is provided on the lower base 6, magnetic poles of the first magnet 71 and the second magnet 72 are opposite. A connection between the upper base 5 and the lower base 6 is achieved through the magnetic attraction effect of the first magnet 71 and the second magnet 72, and can be quickly disassembled by applying a certain external force when disassembly is needed, thereby achieving a quick detachable effect of the quick detachable structure. In an implementation mode, a bottom of the upper base 5 is provided with a first installation slot 81, and the first magnet 71 is embedded in the first installation slot 81. A threaded hole is provided between the first installation slot 81 and the first magnet 71, and a screw 52 is provided between the first installation slot 81 and the first magnet 71 through a threaded hole to improve the stability of the first magnet 71 provided on the upper base 5. The top of the lower base 6 is provided with a second installation slot 82, and the second installation slot 82 is small on a top and large on a bottom. The second installation slot 82 runs through left and right sides of the top of the lower base 6, allowing the second magnet 72 to be embedded and positioned from left and right sides of the top of the lower base 6, thereby ensuring the convenience of installing the second magnet 72 while maintaining good stability.

The sunshade is made of gauze, which is relatively lightweight and flexible, easy to install and store. Compared to traditional heavy fabrics, gauze sunshades are lighter, stretch and shrink more smoothly, and do not take up too much space inside the car. In an implementation mode, the sunshade can also be made of fabric, which usually has high shielding properties. While shading, it can effectively improve the privacy inside the car and avoid external peeping.

### Embodiment 2

This embodiment further discloses a retractable sunshade for car windows.

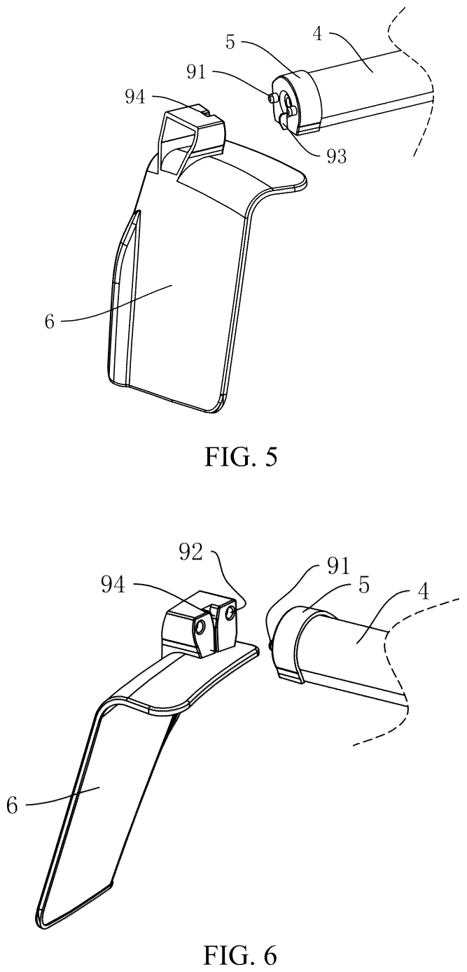

Referring to FIGS. 5 and 6, a difference from embodiment 1 is that both the upper base 5 and the lower base 6 are plastic parts. In this embodiment, the upper base 5 and the lower base 6 are specifically made of polyurethane plastic, which has good elasticity. In an implementation mode, a buckle 91 and a clamp slot 92 are provided between the upper base 5 and the lower base 6. The buckle 91 is provided on one side of the upper base 5, and the clamp slot 92 is provided on one side of the lower base 6. When the upper base 5 is connected to the lower base 6, the buckle 91 is inserted into the clamp slot 92. Besides that, a guide block 93 is provided on one side of the upper base 5, and a guide groove 94 is provided between a top and one side of the lower base 6 configured for the guide block 93 to slide in. The setting of the guide block 93 and the guide groove 94 is used to improve the accuracy of installation between the upper base 5 and the lower base 6, thereby improving installation efficiency.

### Embodiment 3

This embodiment further discloses a retractable sunshade for car windows.

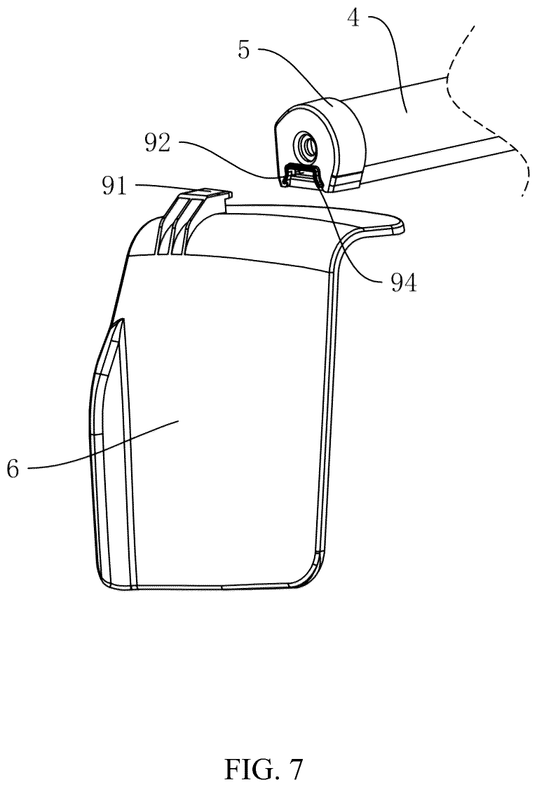

Referring to FIG. 7, a difference from embodiment 2 is that the clamp slot 92 is provided on one side of the upper base 5, and the buckle 91 is provided on the side of the lower base 6. Besides that, the buckle 91 itself serves as a guide block 93, and an edge of the clamp slot 92 is provided with a guide groove 94 with a bottom opening. A bottom of the guide groove 94 allows the guide block 93 to enter, which can also improve the accuracy of installation between the upper base 5 and the lower base 6, thereby improving installation efficiency.

The above are preferred embodiments of the present disclosure and do not limit the protection scope of the present application. Therefore, any equivalent changes made according to the structure, shape, and principle of the present application should be included in the protection scope of the present application.

1. A retractable sunshade for car windows, comprising: a seat body, a roller blind, and a hook;
wherein the seat body comprises a main body, an upper base, and a lower base;
the roller blind is rolled up in the main body, the hook is provided at a rolled-out end of the roller blind, the upper base is fixedly provided at one end of the main body, the lower base is provided at an inner lining of a car door, and a quick release structure is provided between the upper base and the lower base;
the lower base has remained on the inner lining of the car door when the retractable sunshade is removed from the inner lining of the car door by the quick release structure.

2. The retractable sunshade for car windows according to claim 1, wherein the quick release structure between the upper base and the lower base comprises a first magnet and a second magnet, wherein the first magnet is provided at a bottom of the upper base and the second magnet is provided at a top of the lower base.

3. The retractable sunshade for car windows according to claim 2, wherein the bottom of the upper base is provided with a first installation slot, and the first magnet is embedded in the first installation slot.

4. The retractable sunshade for car windows according to claim 3, wherein a second installation slot is provided at the top of the lower base, the second installation slot is small at a top and large at a bottom,
the second installation slot runs through left and right sides of the top of the lower base, and the second magnet is embedded from one side of the top of the lower base.

5. The retractable sunshade for car windows according to claim 1, wherein a buckle and a clamp slot are provided between the upper base and the lower base, the buckle is provided on one side of the upper base, and the clamp slot is provided on one side of the lower base;
when the upper base is connected to the lower base, the buckle is inserted into the clamp slot.

6. The retractable sunshade for car windows according to claim 5, wherein a guide block is provided on one side of the upper base, and a guide groove configured for the guide block to slide in is provided between the top and a side of the lower base.

7. The retractable sunshade for car windows according to claim 5, wherein the upper base and the lower base are both plastic parts.

8. The retractable sunshade for car windows according to claim 1, wherein a buckle and a clamp slot are provided between the upper base and the lower base, the clamp slot is provided on one side of the upper base, and the buckle is provided on one side of the lower base;
when the upper base is connected to the lower base, the buckle is inserted into the clamp slot

9. The retractable sunshade for car windows according to claim 8, wherein the buckle also serves as a guide block, and an edge of the clamp slot is provided with a guide groove with a bottom opening, and a bottom of the guide groove is configured for the guide block to enter.

10. The retractable sunshade for car windows according to claim 8, wherein the upper base and the lower base are both plastic parts.

11. The retractable sunshade for car windows according to claim 1, wherein the main body comprises a tube body, two sides of the tube body of the main body are communicated, and the tube body of the main body is provided with a notch configured for the roller blind to expand and contract.

12. The retractable sunshade for car windows according to claim 11, wherein the upper base is provided with a recess on one side facing the tube body of the main body, and when the upper base is fixedly connected to the main body, one end of the tube body of the main body is inserted into the recess of the upper base.

13. The retractable sunshade for car windows according to claim 1, wherein the sunshade is made of gauze.

14. The retractable sunshade for car windows according to claim 1, wherein the sunshade is made of fabric.

15. The retractable sunshade for car windows according to claim 3, wherein a threaded hole is provided between the first installation slot and the first magnet, and a screw is provided between the first installation slot and the first magnet through the threaded hole.
